(19) United States
(12) Patent Application Publication
(10) Pub. No.: US 2012/0265892 A1
(43) Pub. Date: Oct. 18, 2012

(54) METHOD AND SYSTEM FOR SECURE AND RELIABLE VIDEO STREAMING WITH RATE ADAPTATION

(75) Inventors: Kevin J. Ma, Nashua, NH (US); Radim Bartos, Durham, NH (US); Jianguo Xu, Newton, MA (US); Raj Nair, Lexington, MA (US); Robert Hickey, Bedford, MA (US); IChang Lin, Westborough, MA (US)

(73) Assignee: AZUKI SYSTEMS, INC., Acton, MA (US)

(21) Appl. No.: 13/483,812

(22) Filed: May 30, 2012

Related U.S. Application Data
(63) Continuation of application No. PCT/US2010/058306, filed on Nov. 30, 2010.
Application No. PCT/US2010/058306 is a continuation of application No. PCT/US10/27893, filed on Mar. 19, 2010.
(60) Provisional application No. 61/387,785, filed on Sep. 29, 2010.
(60) Provisional application No. 61/265,391, filed on Dec. 1, 2009.

(51) Int. Cl. G06F 15/16

(52) U.S. Cl. 709/231

(57) ABSTRACT

A system for media delivery includes a server-side proxy for aggregating and encrypting stream data for efficient HTTP-based distribution over an unsecured network. A client-side proxy decrypts and distributes the encapsulated stream data to client devices. A multicast-based infrastructure may be used for increased scalability. The encoded rate of the media delivered over the persistent HTTP proxy connections may be dynamically adapted. The client-side proxy may be integrated within a mobile device for maximum network security and reliability.

### BACKGROUND

The invention relates in general to streaming media and more specifically to implementing secure and reliable streaming media with dynamic bit rate adaptation.

Available bandwidth in the internet can vary widely. For mobile networks, the limited bandwidth and limited coverage, as well as wireless interference can cause large fluctuations in available bandwidth which exacerbate the naturally bursty nature of the internet. When congestion occurs, bandwidth can degrade quickly. For streaming media, which require long lived connections, being able to adapt to the changing bandwidth can be advantageous. This is especially so for streaming which requires large amounts of consistent bandwidth.

In general, interruptions in network availability where the usable bandwidth falls below a certain level for any extended period of time can result in very noticeable display artifacts or playback stoppages. Adapting to network conditions is especially important in these cases. The issue with video is that video is typically compressed using predictive differential encoding, where interdependencies between frames complicate bit rate changes. Video file formats also typically contain header information which describe frame encodings and indices; dynamically changing bit rates may cause conflicts with the existing header information. This is further complicated in live streams where the complete video is not available to generate headers from.

Frame-based solutions like RTSP/RTP solve the header problem by only sending one frame at a time. In this case, there is no need for header information to describe the surrounding frames. However RTSP/RTP solutions can result in poorer quality due to UDP frame loss and require network support for UDP firewall fixups, which may be viewed as network security risks. More recently segment-based solutions like HTTP Live Streaming allow for the use of the ubiquitous HTTP protocol which does not have the frame loss or firewall issues of RTSP/RTP, but does require that the client media player support the specified m3u8 playlist polling. For many legacy mobile devices that support RTSP, and not m3u8 playlists, a different solution is required.

Within the mobile carrier network, physical security and network access control provide content providers with reasonable protection from unauthorized content extrusion, at a network level. Similarly the closed platforms with proprietary interfaces used in many mobile end-point devices prevent creation of rogue applications to spoof the native end-point application for unauthorized content extrusion. However, content is no longer solely distributed through the carrier network alone, and not all mobile end-point devices are closed platforms anymore. Over the top (OTT) delivery has become a much more popular distribution mechanism, bypassing mobile carrier integration, and recent advancements in smart phone and smart pad platforms (e.g., Apple iPhone, Blackberry, and Android) have made application development and phone hacking much more prevalent. The need to secure content delivery paths is critical to the monetization of content and the protection of content provider intellectual property.

In addition to security, high quality video delivery is paramount to successful monetization of content. Traditional video streaming protocols, e.g., RTSP/RTP, are based on unreliable transport protocols, i.e., UDP. The use of UDP allows for graceful degradation of quality by dropping or ignoring late and lost packets, respectively. While this helps prevent playback interruptions, it causes image distortion when rendering video content. Within a well-provisioned private network where packet loss and lateness is known to be minimal, UDP works well. UDP also allows for the use of IP multicast for scalability. In the public Internet, however, there are few network throughput or packet delivery guarantees. The lack of reliability causes RTSP/RTP-based video streaming deployments to be undesirable given their poor quality.

Methods such as layered video encodings, multiple description video encodings (MDC), and forward error correction (FEC) have been proposed to help combat the lack of reliable transport in RTSP/RTP. These schemes distribute data over multiple paths and/or send redundant data in order to increase the probability that at least partially renderable data is received by the client. Though these schemes have been shown to improve quality, they add complexity and overhead but are still not guaranteed to produce high quality video. A different approach is required for integrating secure delivery of high quality video into the RTSP/RTP delivery infrastructure.

### SUMMARY

A method is provided for integrating and enhancing the reliability and security of streaming video delivery protocols. The method can work transparently with standard HTTP servers and use a file format compatible with legacy HTTP infrastructure. Media may be delivered over a persistent connection from a single server or a plurality of servers. The method can also include the ability for legacy client media players to dynamically change the encoded rate of the media delivered over a persistent connection. The method may require no client modification and can leverage standard media players embedded in mobile devices for seamless media delivery over wireless networks with high bandwidth fluctuations. The method may be used with optimized multicast distribution infrastructure.

Generally, the method for distributing live streaming data to clients includes a first (server-side) proxy connecting to a streaming server, aggregating streaming data into file segments and writing the file segments to one or more storage devices. The file segments are transferred from the storage devices to a second (client-side) proxy, which decodes and parses the file segments to generate native live stream data and serves the native live stream data to clients for live media playback.

A system is also specified for implementing a client and server proxy infrastructure in accordance with the provisions of the method. The system includes a server-side proxy for aggregating and encrypting stream data for efficient HTTP-based distribution over an unsecured network. The system further includes a client-side proxy for decrypting and distributing the encapsulated stream data to the client devices. The distribution mechanism includes support for multicast-based infrastructure for increased scalability. The method further support for dynamically adapting the encoded rate of the media delivered over the persistent HTTP proxy connections. An additional system is specified for integrating the client-side proxy within a mobile device for maximum network security and an reliability.

### BRIEF DESCRIPTION OF THE DRAWINGS

The foregoing and other objects, features and advantages will be apparent from the following description of particular embodiments of the invention, as illustrated in the accompanying drawings.

FIG. 1 is a block diagram of a system which is capable of conducting procedures, in accordance with various embodiments of the invention;

FIG. 2 is another block diagram of a system which is capable of conducting procedures, in accordance with various embodiments of the invention;

FIG. 3 is another block diagram of a system which is capable of conducting procedures, in accordance with various embodiments of the invention;

FIG. 4 is a diagram of a segment file format used, in accordance with an embodiment of the present invention;

FIG. 5 is a flow chart showing a method for performing stream segmentation, in accordance with various embodiments of the invention;

FIG. 6 is a flow chart showing a method for performing stream segment retrieval and decoding, in accordance with an embodiment of the present invention;

FIG. 7 is a flow chart showing another method for performing stream segment retrieval and decoding, in accordance with an embodiment of the present invention;

FIG. 8 is a block diagram of a proxy capable of performing server-side transcoding, encapsulation, and streaming services, in accordance with an embodiment of the present invention;

FIG. 9 is a block diagram of a proxy capable of performing RTSP client-side decapsulation, parsing, and streaming services, in accordance with an embodiment of the present invention;

FIG. 10 is a block diagram of another proxy capable of performing HLS client-side decapsulation, parsing, and streaming services, in accordance with an embodiment of the present invention;

FIG. 11 is another block diagram of a system which is capable of conducting procedures in accordance with various embodiments of the invention; and

FIG. 12 is a flow chart showing a method for performing segment retrieval failover, in accordance with an embodiment of the present invention.

### DETAILED DESCRIPTION

### Overview

In one embodiment, the present invention provides a method for delivering streaming data over a network. In one embodiment, the invention is described as being integrated into an existing Real-Time Streaming Protocol/ Real-Time Protocol (RTSP/RTP) video delivery infrastructure, however, the invention is generally suitable for tunneling any real-time streaming protocol; RTSP/RTP just happens to be a predominant protocol and is therefore of focus. In another embodiment, the invention is suitable for integration into an HTTP Live Streaming (HLS) video delivery infrastructure. In another embodiment, the invention is suitable for integration into Real-Time Messaging Protocol (RTMP) video delivery infrastructure. In another embodiment, the invention is suitable for integration into an Internet Information Services (IIS) Smooth Streaming video delivery infrastructure.

In one embodiment, the invention includes a server-side proxy and one or more client-side proxies. The server-side proxy connects to one or more streaming servers and records the data in batches. In one embodiment, the streaming server is an RTSP server and the data is RTP/RTCP data. The RTP and RTCP data is written into segment files along with control information used to decode the segments by the client-side proxies. In another embodiment, the streaming server is an HLS server and the data is MPEG transport stream (MPEG-TS) data, where MPEG stands for “Motion Picture Experts Group” as known in the art. In another embodiment, the streaming server is an RTMP server and the data is RTMP data. In another embodiment, the streaming server is an IIS Smooth Streaming server and the data is MPEG-4 (MP4) fragment data. In one embodiment, the segment is then encrypted by the server-side proxy. In one embodiment, encryption uses the AES 128 block cipher. In another embodiment, the encryption uses the RC4 stream cipher. In another embodiment, the encryption uses the HC128 stream cipher. In another embodiment, the encryption uses the AES128 counter mode (CTR) stream cipher. There are many encryption methods, as should be familiar to those skilled in the art; any valid encryption method may be used. The segment is then available for transmission to the client-side proxies.

In one embodiment, client-side proxies initiate persistent HTTP connections to the server-side proxies, and the segments are streamed out as they become available. The segments are sent using the HTTP chunked transfer encoding so that the segment sizes and number of segments do not need to be known a priori. In another embodiment, the client-side proxies may use non-persistent HTTP requests to poll the server-side proxy for new segments at fixed intervals. In another embodiment, the client-side proxies initiate persistent HTTP connections to a CDN to retrieve the segments. In another embodiment, the client-side proxies initiate non-persistent HTTP connections to a CDN to retrieve the segments at fixed intervals. In another embodiment, the client-side proxies may use FTP requests to poll for new segments at fixed intervals. In one embodiment, HTTP connections may be secured (i.e., HTTPS) using SSL/TLS to provide data privacy when retrieving segments. In another embodiment, the FTP connections may be secure (i.e., SFTP/SCP) to provide data privacy when retrieving segments. In one embodiment, the segment files adhere to a file naming convention which specifies the bitrate and format in the name, to simplify segment polling and retrieval.

In one embodiment, the server-side proxy connects to a single streaming server retrieving a single video stream. In one embodiment, the streaming server is an RTSP server. Each RTSP connection should be accompanied by at least one audio RTP channel, one audio RTCP channel, one video RTP channel, and one video RTCP channel, as should be known to those skilled in the art. Herein, this group of RTSP/RTP/RTCP connections is considered a single atomic stream. In one embodiment, the stream contains a high definition video stream. This source video is transcoded into a plurality of different encodings. In one embodiment only the video bitrates differ between encodings. In another embodiment, the video bitrates, frame rates, and/or resolution may differ. The different encodings are written into separate file segments.

In another embodiment, the server-side proxy connects to a single streaming server retrieving a plurality of streams. Each stream is for the same source video content, with each stream encoded differently. In another embodiment, the server-side proxy connects to a single RTSP server to retrieve a plurality of streams. In one embodiment, each stream in the plurality of streams contains the same content encoded differently. In one embodiment only the video bitrates differ. In another embodiment, the video bitrates, frame rates, and/or resolution may differ. The client-side proxy may request that one or more bitrates be sent to it over a persistent HTTP connection. The client-side proxy may choose a different bitrate or set of bitrates by initiating a new persistent HTTP connection to the server-side proxy. The client-side proxy may select any segments it wishes when using a polling-based approach.

In another embodiment, the server-side proxy connects to a plurality of streaming servers retrieving multiple streams which are to be spliced together. In one embodiment, an advertisement may be retrieved from one server, while the main content is retrieved from another server, and the advertisement is spliced in at designated intervals. In another embodiment, one viewing angle for an event may be available on one server, while another viewing angle may be available on the other server, and the different viewing angles are to be switched between. In one embodiment the splicing and switching is done based on a fixed schedule that is known a priori. In another embodiment the splicing and switching is done on demand based on user input.

In one embodiment, the segments are all of a fixed duration. In another embodiment, the segments may all be of a fixed size. In one embodiment, video segments are packed to integer time boundaries. In another embodiment compressed and/or encrypted segments are padded out to round numbered byte boundaries. This can help simplify byte-based offset calculations. It also can provide a level of size obfuscation, for security purposes. In another embodiment the segments may be of variable duration or size. In one embodiment, video segments are packed based on key frame or group of frame counts.

In one embodiment, the segments are served from standard HTTP servers. In another embodiment, the segments may be served from an optimized caching infrastructure. The segments are designed to be usable with existing infrastructure. They do not require special servers for delivery and they do not require decoding for delivery. They also do not require custom rendering engines for displaying the content.

In one embodiment, the client-side proxy acts as an RTSP server for individual client devices. The client-side proxy decodes the segments retrieved from the server-side proxy and replays the RTP/RTCP content contained within the segment. The RTP/RTCP headers may be spoofed to produce valid sequence numbers and port numbers, etc., for each client device. The methods for header field rewrite for spoofing prior to transmission should be known to those skilled in the art. In one embodiment, the client-side proxy is embedded inside a client application, directly interacting with only the local device's native media player. In another embodiment, the client-side proxy acts as an HLS server for individual client devices. The client-side proxy tracks segment availability and creates m3u8 playlists for the client. In another embodiment, the client-side proxy acts as a standalone device, serving multiple client endpoints. In one embodiment, the client-side proxy accepts individual connections from each endpoint. In another embodiment, the client-side proxy distributes the RTP/RTCP data via IP multicast. The client devices join an IP multicast tree and receive the data from the network, rather than making direct connections to the client-side proxy.

In one embodiment, the invention uses bandwidth measurements to determine when a change in bitrate is required. If the estimated bandwidth falls below a given threshold for the current encoding, for a specified amount of time, then a lower bit rate encoding should be selected. Likewise if the estimated bandwidth rises above a different threshold for the current encoding, for a different specified amount of time, then a higher bit rate encoding may be selected. The rate change takes place at the download of the next segment.

In one embodiment, the bandwidth is estimated based on the download time for each segment (S/T), where S is the size of the segment and T is the time elapsed in retrieving the segment. In one embodiment, the downloader keeps a trailing history of B bandwidth estimates, calculating the average over the last B samples. When a new sample is taken, the Bth oldest sample is dropped and the new sample is included in the average:

| | |
|---|---|
| integer B_index | // tail position in the circular history buffer |
| integer B_total | // sum of all the entries in the history buffer |
| integer B_count | // total number of entries in the history buffer |
| integer B_new | // newly sampled bandwidth measurement |
| integer B_old | // oldest bandwidth sample to be replaced |
| integer B_average | // current average bandwidth |
| array B_history | // circular history buffer |

| | |
|---|---|
| B_old = B_history[B_index] | // find the sample to be replaced |
| B_history[B_index] = B_new | // replace the sample with the |
| | new sample |
| B_total = B_total − B_old | // remove the old sample |
| | from the sum |
| B_total = B_total + B_new | // add the new sample |
| | into the sum |
| B_average = B_total / B_count | // update the average |
| B_index = (B_index + 1) % B_count | // update the buffer index |

The history size should be selected so as not to tax the client device. A longer history will be less sensitive to transient fluctuations, but will be less able to predict rapid decreases in bandwidth. In another embodiment the downloader keeps only a single sample and uses a dampening filter for statistical correlation.

| | |
|---|---|
| integer B_new | // newly sampled bandwidth measurement |
| integer B_average | // current average bandwidth |
| float B_weight | // weight of new samples, between 0 and 1 |

B_average = (B_average * (1 − B_weight)) + (B_average *
B_weight) // update the average

This method requires less memory and fewer calculations. It also allows for exponential drop off in historical weighting. In one embodiment, download progress for a given segment is monitored periodically so that the segment size S of the retrieved data does not impact the rate at which bandwidth measurements are taken. There are numerous methods for estimating bandwidth, as should be known to those skilled in the art; the above are representative of the types of schemes possible but do not encompass an exhaustive list of schemes. Other bandwidth measurement techniques as applicable to the observed traffic patterns are acceptable within the context of the present invention.

Live RTP data is typically sent just-in-time (JIT) by the RTSP server, so the data received by the server-side proxy is naturally paced. The server-side proxy does not need to inject additional delay into the distribution of segments, nor does the client-side proxy need to inject additional pacing into the polling retrieval of segments. The data is received by the server-side proxy and packed into segments. Once the segment is complete, the segment is immediately distributed to the client-side proxies. The client-side proxies then immediately distribute the data contained in the segment to the client devices. If the segment sizes are large, then the client-side proxy paces the delivery of RTP data to the client devices. In one embodiment, the client-side proxy inspects the RTP timestamps produced by the RTSP server, and uses them as a guideline for pacing the RTP/RTCP data to the client devices. In one embodiment, the segments are made available for video on demand (VoD) playback once they have been created. If the segments already exist on the storage device, then they could be downloaded as fast as the network allows. In one embodiment, the server-side proxy paces the delivery of segments to the client-side proxy. In another embodiment, the client-side proxy requests segments from the server-side proxy in a paced manner. In another embodiment, the client-side proxy requests segments from the CDN in a paced manner. The pacing rate is determined by the duration of the segments. The segments are delivered by the server-side proxy or retrieved by the client-side proxy JIT to maximize network efficiency.

In one embodiment, the invention uses bandwidth measurements to determine when a change in bitrate is required. If the estimated bandwidth falls below a given threshold for the current encoding, for a specified amount of time, then a lower bit rate encoding should be selected. Likewise if the estimated bandwidth rises above a different threshold for the current encoding, for a different specified amount of time, then a higher bit rate encoding may be selected. In one embodiment, the rate change is initiated by the server-side proxy. The server-side proxy uses TCP buffer occupancy rate to estimate the network bandwidth. When the estimated available bandwidth crosses a rate change threshold, the next segment delivered is chosen from a different bitrate. In another embodiment, the rate change is initiated by the client-side proxy. The client-side proxy uses segment retrieval time to estimate the network bandwidth. When the estimated available bandwidth crossed a rate change threshold, the next segment requested is chosen from a different bitrate.

In the description that follows, a single reference number may refer to analogous items in different embodiments described in the figures. It will be appreciated that this use of a single reference number is for ease of reference only and does not signify that the item referred to is necessarily identical in all pertinent details in the different embodiments. Additionally, as noted below, items may be matched in ways other than the specific ways shown in the Figures.

### Description of Illustrative Embodiments

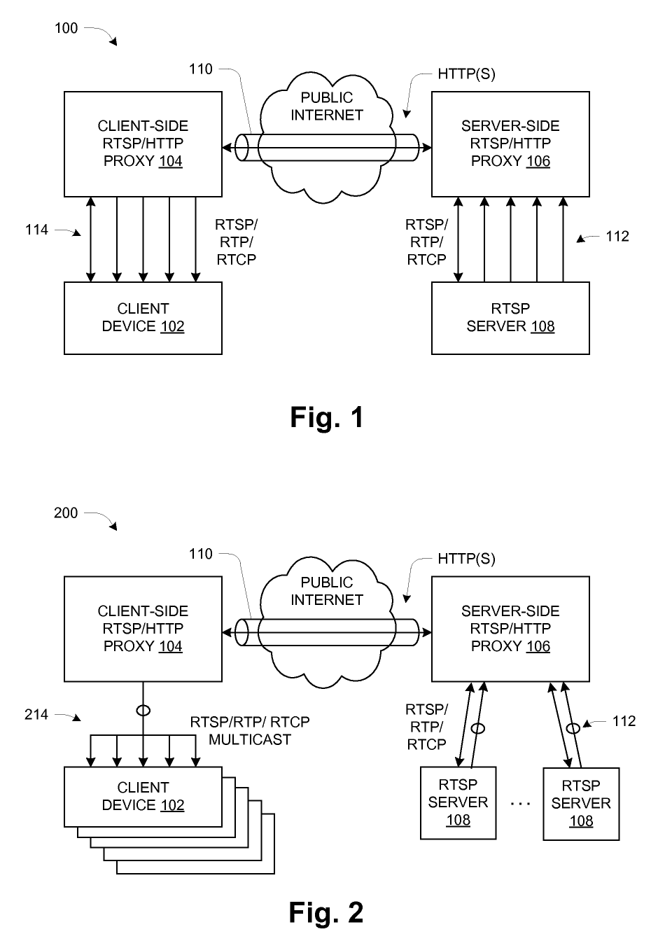

In FIG. 1 is a block diagram 100 for one embodiment of the present invention. It shows a streaming server 108 (shown as an RTSP server 108), a server-side proxy 106, a client-side proxy 104, and a client device 102. The streaming server 108, the server-side proxy 106, the client-side proxy 104, and the client device 102 are all typically computerized devices which include one or more processors, memory, storage (e.g., magnetic or flash memory storage), and input/output circuitry all coupled together by one or more data buses, along with program instructions which are executed by the processor out of the memory to perform certain functions which are described herein. Part or all of the functions may be depicted by corresponding blocks in the drawings, and these should be understood to cover a computerized device programmed to perform the identified function.

In the interest of specificity, the following description is directed primarily to an embodiment employing RTSP. As described below, other types of streaming protocols, servers, and connections may be employed. The references to RTSP in the drawings and description are not to be taken as limiting the scope of any claims not specifically directed to RTSP.

The server-side proxy 106 initiates a real-time streaming connection 112 (shown as RTSP connection 112) to the RTSP server 108. The RTSP connection 112 shown contains a bi-directional RTSP control channel, and four unidirectional RTP/RTCP data channels (i.e., one audio RTP channel, one audio RTCP channel, one video RTP channel, and one video RTCP channel), all of which constitutes a single stream. The server-side proxy 106 captures the data from all four RTP/RTCP channels and orders them based on timestamps within the packets. The packets are then written to a segment file. A header is added to each of the individual packets to make the different channels distinguishable when parsed by the client-side proxy 104. Once the segment file has reached its capacity, the file is closed and a new file is started. In one embodiment, the file capacity is based on the wall-clock duration of the stream, e.g., 10 seconds of data. In another embodiment, the file capacity is based on video key frame boundaries, e.g. 10 seconds of data plus any data until the next key frame is detected. In another embodiment, then file capacity is based on file size in bytes, e.g., 128 KB plus any data until the next packet.

In one embodiment, the server-side proxy 106 takes the recorded stream and transcodes it into a plurality of encodings. In one embodiment only the video bitrates differ between encodings. In another embodiment, the video bitrates, frame rates, and/or resolution may differ.

The client device 102 initiates a real-time streaming connection 114 (shown as RTSP connection 114) to the client-side proxy 104. The RTSP connection 114 shown contains a bi-directional RTSP control channel, and four unidirectional RTP/RTCP data channels (i.e., one audio RTP channel, one audio RTCP channel, one video RTP channel, and one video RTCP channel), all of which constitutes a single stream. The client-side proxy 104 initiates a connection 110 to the server-side proxy 106. In one embodiment, the connection 110 is a persistent HTTP connection. In another embodiment, the connection 110 is a persistent HTTPS connection. In another embodiment, the connection 110 is a onetime use HTTP connection. In another embodiment, the connection 110 is a onetime use HTTPS connection. In another embodiment, the connection 110 is a persistent FTP, SFTP, or SCP connection. In another embodiment, the connection 110 is a onetime use FTP, SFTP, or SCP connection.

In one embodiment, the client-side proxy 104 requests the first segment for the stream from the server-side proxy 106. In another embodiment the client-side proxy 104 requests the current segment for the stream from the server-side proxy 106. If the stream is a live stream, the current segment will provide the closest to live viewing experience. If the client device 102 prefers to see the stream from the beginning, however, it may request the first segment, whether the stream is live or not. In one embodiment, the server-side proxy 106 selects the latest completed segment and immediately sends it to the client-side proxy 104. In another embodiment, the server-side proxy 106 selects the earliest completed segment and immediately sends it to the client-side proxy 104. For some live events, the entire history of the stream may not be saved, therefore, the first segment may be mapped to the earliest available segment. For video on demand (VoD), the first segment should exist, and will be the earliest available segment.

For persistent HTTP/HTTPS connections, segments are sent as a single HTTP chunk, as defined by the HTTP chunk transfer encoding. Subsequent segments will be sent as they become available as separate HTTP chunks, as should be familiar to those skilled in the art. For onetime use HTTP/HTTPS and FTP/SFTP/SCP, the client-side proxy 104 polls for the availability of the next segment using the appropriate mechanism for the specific protocol, as should be familiar to those skilled in the art. Though only one client-side proxy 104 is shown, multiple client-side proxies 104 may connect to a single server-side proxy 106. A client-side proxy 104 may also connect to multiple server-side proxies 106.

The client-side proxy 104 decodes the segments and parses out the component RTP/RTCP stream data and forwards the data to the client device 102. The RTP/RTCP data is paced as per the RTP specification. The client-side proxy 104 uses the timestamp information in the RTP/RTCP packet headers as relative measures of time. The timing relationship between packets should be identical, as seen by the client device 102, to the timing relationship when the stream was recorded by the server-side proxy 106. The timestamps and sequence numbers are updated, however, to coincide with the specific client device 102 connection. Manipulation of the RTP/RTCP header information to normalize timestamps and sequence numbers should be familiar to those skilled in the art.

The client device 102 delivers the data to the a media player on client device 102 which renders the stream. The HTTP proxy infrastructure is transparent to the native media player which receives RTSP/RTP data as requested.

In FIG. 2 is a block diagram 200 for another embodiment of the present invention. As with FIG. 1, it shows an RTSP server 108, the server-side proxy 106, the client-side proxy 104, and a client device 102. FIG. 2, however, shows a plurality of RTSP servers 108 and a plurality of client devices 102. The connections 112 between the server-side proxy 106 and the RTSP servers 108 are the same, there are just multiple of them. Each connection 112 attaches to a different RTSP server 108, to retrieve different content which is to be spliced together. In one embodiment, one RTSP server 108 may contain a live event which pauses for commercial interruptions, while one or more other RTSP servers 108 may contain advertisements which are to be inserted during the commercial breaks. In another embodiment, multiple RTSP servers 108 may contain different camera angles for a given live event, where a final video stream switches between the different camera angles. In one embodiment, the splicing of streams (advertisements) and/or the switching of streams (camera angles) is determined before the event and performed on a set schedule. In another embodiment, the splicing of streams (advertisements) and/or the switching of streams (camera angles) is determined live by user intervention. Though only one client-side proxy 104 is shown, multiple client-side proxies 104 may connect to a single server-side proxy 106. A client-side proxy 104 may also connect to multiple server-side proxies 106.

In one embodiment, the server-side proxy 106 takes each of the recorded streams and transcodes them into a plurality of encodings. In one embodiment only the video bitrates differ between encodings. In another embodiment, the video bitrates, frame rates, and/or resolution may differ.

The connection 110 between the client-side proxy 104 and the server-side proxy 106 is the same as in the discussion of FIG. 1. The segment parsing and RTP/RTCP packet normalization and pacing performed by the client-side proxy 104 is also the same as in the discussion of FIG. 1. The connection 214 between the client devices 102 and the client-side proxy 104 is via a multicast connection such as an IP multicast distribution tree. The client-side proxy 104 and client devices 102 connect to the multicast distribution tree through a multicast registration protocol, e.g., IGMP. A multicast router infrastructure is typically required. The client-side proxy 104 then sends the RTP/RTCP data to a multicast address, and does not communicate with client devices 102 directly. The client devices 102 receive the live data from the multicast tree and deliver the data to the native media player which renders the stream. The HTTP proxy infrastructure is transparent to the native media player which receives RTSP/RTP data as requested.

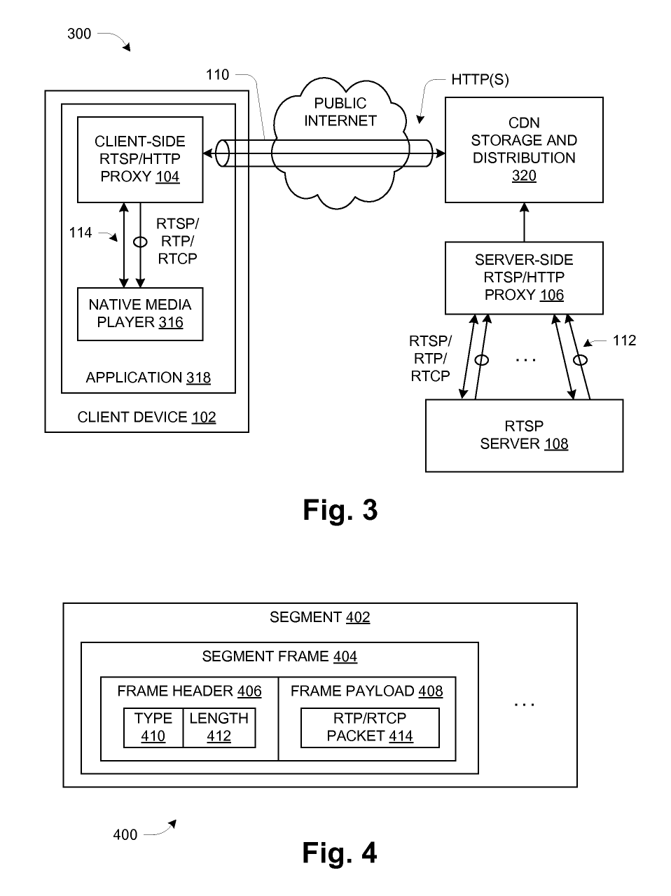

FIG. 3 is a block diagram 300 for another embodiment of the present invention. As with FIGS. 1 and 2, it shows an RTSP server 108, the server-side proxy 106, the client-side proxy 104, and a client device 102. FIG. 3, however, shows a single server-side proxy 106 with multiple RTSP connections 112 to it. The server-side proxy 106 connects to a CDN 320 for remote storage of the generated segments. FIG. 3 also shows a more detailed view of the client device 102, with an integrated client-side proxy 104. Each RTSP connection 112 connects to the same RTSP server 108. In one embodiment, the each RTSP connection 112 retrieves the same content, each encoded at a different bitrate, frame rate, and/or resolution. The server-side proxy 106 makes multiple simultaneous RTSP connections 112 to the RTSP server 108 and records all of the different encodings so that it can service a request for any of the different encodings at any time. In another embodiment, each RTSP connection 112 retrieves different content and the server-side proxy 106 takes the recorded streams and transcodes them into a plurality of encodings. In one embodiment only the video bitrates differ between encodings. In another embodiment, the video bitrates, frame rates, and/or resolution may differ. Though only one client-side proxy 104 is shown, multiple client-side proxies 104 may connect to the CDN 320. A client-side proxy 104 may also connect to multiple CDNs 320.

The client-side proxy 104 is integrated into the client device 102, by being embedded into a client device application 318. The client device application 318 integrates the client-side proxy 104 software to provide direct access to the native media player 316. This integration provides the highest level of security as the HTTP proxy security is extended all the way to the client device 102. Whether it is the transport security of HTTPS or the content security of the segment encryption, extending the security later to the client device 102 prevents the possibility of client-side man-in-the-middle attacks. In one embodiment, the connection 110 between the client-side proxy 104 and the CDN 320 is a persistent HTTP connection. In another embodiment, the connection 110 is a persistent HTTPS connection. In another embodiment, the connection 110 is a onetime use HTTP connection. In another embodiment, the connection 110 is a onetime use HTTPS connection. In another embodiment, the connection 110 is a persistent FTP, SFTP, or SCP connection. In another embodiment, the connection 110 is a onetime use FTP, SFTP, or SCP connection.

In one embodiment, the client-side proxy 104 requests the first segment for the stream from the CDN 320. In another embodiment the client-side proxy 104 requests the current segment for the stream from the CDN 320. If the stream is a live stream, the current segment will provide the closest to live viewing experience. If the client device 102 prefers to see the stream from the beginning, however, it may request the first segment, whether the stream is live or not. For some live events, the entire history of the stream may not be saved, therefore, if the first segment does not exist, the current segment should be retrieved. For video on demand (VoD), the first segment should exist.

The client-side proxy 104 polls for the availability of the next segment using the appropriate mechanism for the specific protocol, as should be familiar to those skilled in the art. The segment parsing and RTP/RTCP packet normalization and pacing performed by the client-side proxy 104 is the same as in the discussion of FIG. 1. The connection 114 between the client devices 102 and the client-side proxy 104 is the same as in the discussion of FIG. 1. The native media player 318 receives the data directly from the client-side proxy 104 and renders the stream. The HTTP proxy infrastructure is transparent to the native media player which receives RTSP/RTP data as requested.

To support rate adaptation, the client-side proxy 104 measures the bandwidth and latency of the segment retrieval from the server-side proxy 106 or CDN 320. In one embodiment, the client-side proxy 104 calculates the available bandwidth based on download time and size of each segment retrieved. In one embodiment, bitrate switching is initiated when the average bandwidth falls below the current encoding's bitrate or a higher bitrate encoding's bitrate:

| | |
|---|---|
| int bandwidth_avg | // average available network bandwidth |
| int video_bit_rate | // current video encoding bit rate |

```
      if bandwidth_avg < video_bit_rate
        for each encoding sorted by bit rate in descending order
          if encoding.bit_rate < bandwidth_avg &&
encoding.bit_rate != video_bit_rate
            change encoding
            break
          end
        end
      end
```

In one embodiment, when an encoding change is desired, the client-side proxy 104 will terminate its existing persistent HTTP connection and initiate a new persistent HTTP connection requesting the data for the new encoding. In another embodiment, polled approaches just switch the segment type requested from the server-side proxy 106 or CDN 320 by the client-side proxy 104.

FIG. 4 is a diagram 400 of a segment format which may be used in accordance with an embodiment of the present invention. The segment 402 contains a plurality of segment frames 404. Each segment frame 404 consists of a frame header 406 and a frame payload 408. The frame header 406 contains frame type information 410 and frame payload length information 412. In one embodiment, the frame type indicates the payload channel information (audio RTP, audio RTCP, video RTP, and/or video RTCP) as well as any additional information about the payload framing. The frame payload length 412 indicates the length of the segment frame payload section 408. The frame payload length 412 may be used to parse the segment sequentially, without the need for global index headers and metadata to be packed at the beginning of the segment. In one embodiment, the frame header 406 is aligned to 4 or 8 byte boundaries to optimize copying of the frame payload 408. In one embodiment, the frame payload 408 contains an RTP or RTCP packet 414. In one embodiment, RTP protocol pads the frame payload 408 out to a 4 or 8 byte boundary, to ensure that the frame header 406 is 4 or 8 byte aligned, respectively.

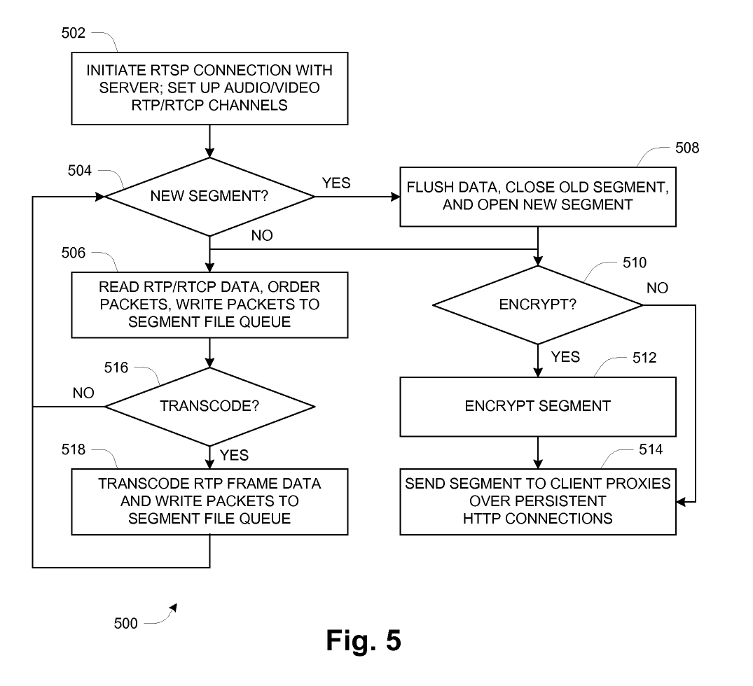

FIG. 5 is a flow chart 500 describing the process of retrieving content from an RTSP server 108 and generating segments in the server-side proxy 106. In step 502, the server-side proxy 106 initiates a connection to the RTSP server 108, setting up the necessary RTP/RTCP channels (i.e., audio RTP, audio RTCP, video RTP, and/or video RTCP). In step 504, it checks to see if a new segment file is needed. In the case of a new connection, a new segment file is needed. In the case of an existing connection, the segment file contents are checked against segment file capacity thresholds. In one embodiment, the file capacity is based on the wall-clock duration of the stream, e.g., 10 seconds of data. In another embodiment, the file capacity is based on video key frame boundaries, e.g. 10 seconds of data plus any data until the next key frame is detected. In another embodiment, then file capacity is based on file size in bytes, e.g., 128 KB plus any data until the next packet. If the threshold is not met, processing continues to step 506. If the threshold has been met, or the connection is new, processing continues to step 508. The processing from step 508 for existing connections is described below. For new connections, step 508 simply opens a new segment which is used during the processing of steps 506 through 516/518 for the first segment of a new connection.

In step 506, the server-side proxy 106 reads from the RTP/RTCP connections. The reads are performed periodically. In one embodiment, a delay is inserted at the beginning of step 506, e.g., 1 second, to allow RTP/RTCP data to accumulate in the sockets. The data from all RTP/RTCP channels is read, and ordered. In one embodiment, packets are inserted into a priority queue, based on their timestamps. Enforcing time-based ordering simplifies the parsing for the client-side proxy 104. The priority queue allows data to be written into segments based on different segment sizing criteria. In one embodiment, packet data from the priority queue is later read and written to the segment file. This allows the segment file to write less than the amount of data that was read from the sockets. In another embodiment, RTP/RTCP packets are written directly into the segment file.

Once a batch read is completed, the processing proceeds to step 516 to check and see if any transcoding is required. If transcoding is required, processing proceeds to step 518 where the transcoding occurs. In one embodiment, a plurality of queues are maintained, one for each transcoding. The RTP frame data is reassembled and transcoded using methods which should be known to those skilled in the art. In one embodiment only the video bitrates differ between encodings. In another embodiment, the video bitrates, frame rates, and/or resolution may differ. The transcoded frames are re-encapsulated using the existing RTP headers that were supplied with the original input. The encapsulated frames are written to the corresponding queues associated with each encoding.

Once transcoding is complete, or if no transcoding was required, processing proceeds back to step 504 to check and see if the segment thresholds have been met with the newly read data. The loop from 504 through 516/518 is repeated until the segment threshold is reached in step 508.

In step 508, the data for the segment is flushed out to a file and the file is closed. In one embodiment, the threshold checking performed in step 504 indicates how much data to pull from the priority queue and write to the file. Once the file has been written, the buffers are flushed and the file is closed. In another embodiment, the data has already been written to the segment file in step 506 and only a buffer flush is required prior to closing the file. Once the buffer has been flushed, two parallel paths are executed. In one execution path, processing proceeds back to step 506 for normal channel operations. In another execution path, starting in step 510, post processing is performed on the segment and the segment is delivered to the client. In step 510, a check is done to see if segment encryption is required. If no segment encryption is required processing proceeds to step 514. If segment encryption is required, processing proceeds to step 512 where the segment encryption is performed. The segment encryption generates a segment specific seed value for the encryption cipher. In one embodiment, the encryption seed is based off of a hash (e.g., MD5 or SHAT) of the shared secret and the segment number. Other seed generation techniques may also be used, as long as they are reproducible and known to the client-side proxy 104. Once the segment has been encrypted, processing proceeds to step 514. In step 514, the segment is read for delivery to the client-side proxy 104. If the client-side proxy 104 has initiated a persistent HTTP connection to the server-side proxy 106, the segment is sent out over the persistent HTTP connection. The segment name, which contains meaningful information about the segment (e.g., segment number, encoding type, and encryption method) is sent first, and then the segment itself is sent after. Each is sent as an individual HTTP chunk.

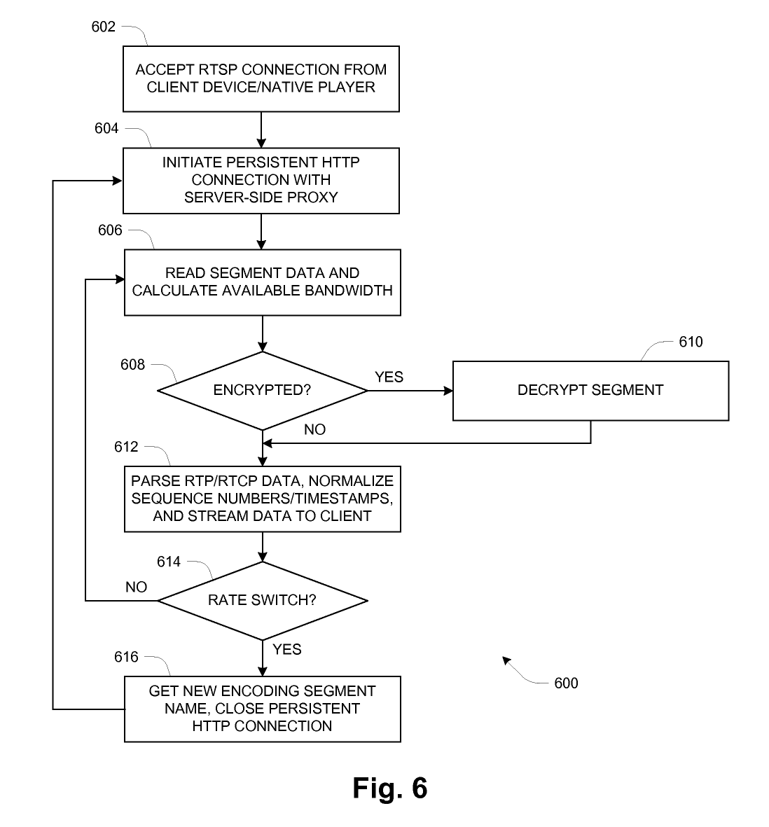

FIG. 6 is a flow chart 600 describing the process of retrieving content from the server-side proxy 106 or CDN 320 and redistributing that content over RTSP connections 114 or multicast trees 214 to client devices 102 from the client-side proxy 104. In step 602, the client-side proxy 104 accepts an RTSP connection from the client device 102. In step 604, the client-side proxy 104 then initiates a persistent HTTP connection to the server-side proxy 106 or CDN 320. In one embodiment, a persistent HTTPS connection using SSL/TLS to secure the connection is initiated. The HTTP GET request indicates a segment name. The segment name contains meaningful information about the segment (e.g., segment number, encoding type, encryption method, and the source content identifier). The server-side proxy 106 associates the request with an existing backend process 500 (FIG. 5), or creates a new backend process 500 to service the request. Processing then proceeds to step 606 where the client-side proxy 104 waits for a segment to be sent by the server-side proxy 106. When the segment is received by the client-side proxy 104, the client-side proxy 104 calculates the time it took to receive the segment, and uses that to compute a bandwidth estimate. The bandwidth estimate is used at a later point to check and see if a rate switch should be initiated.

The segment pre-processing starts in step 608. In step 608, the segment is checked to see if it is encrypted. In one embodiment, encryption is denoted by the segment name. If the segment is encrypted, then processing proceeds to step 610 where the segment is decrypted. Once the segment is decrypted, or if the segment was not encrypted, processing proceeds to step 612. In step 612, the segment is parsed and the RTP/RTCP contents are retrieved. The RTP/RTCP headers are normalized so that port numbers, sequence numbers, and timestamps provided by the RTSP server 108 to the server-side proxy 106, are converted to match the connection parameters negotiated between the client-side proxy 104 and the client device 102. The RTP/RTCP packets are then queued for transmission to the client device 102. Relative time-based pacing is implemented so as not to overrun the client device 102. In one embodiment, each packet is paced exactly using the difference in timestamps from the original RTP/RTCP packets to determine the delay between packet transmissions. In another embodiment, packets are sent in bursts, using the difference in timestamps from the original RTP/RTCP packets to determine the delay between packet burst transmissions. Once all the packets from the current segment have been sent, processing proceeds to step 614.

In step 614, a check is performed to see if a rate switch is desired. The bandwidth estimate information gathered in step 606 is compared with the bitrate of the segment that was just retrieved. If the available bandwidth is less than, or very near the current video encoding's bitrate, then a switch to a lower bitrate may be warranted. If the available bandwidth is significantly higher than the current encoding's bitrate and a higher bitrate encoding's bitrate, then a switch to a higher bitrate may be acceptable. If no rate switch is desired, then processing proceeds back to step 606 to await the next segment. If a rate switch is desired, processing proceeds to step 616 where the new bitrate and new segment name are determined. The current persistent HTTP connection is then terminated, and processing proceeds back to step 604 to initiate a new persistent HTTP connection. In one embodiment, the check for a rate switch may be performed in parallel with segment decryption and parsing to mask the latency of setting up the new persistent HTTP connection.

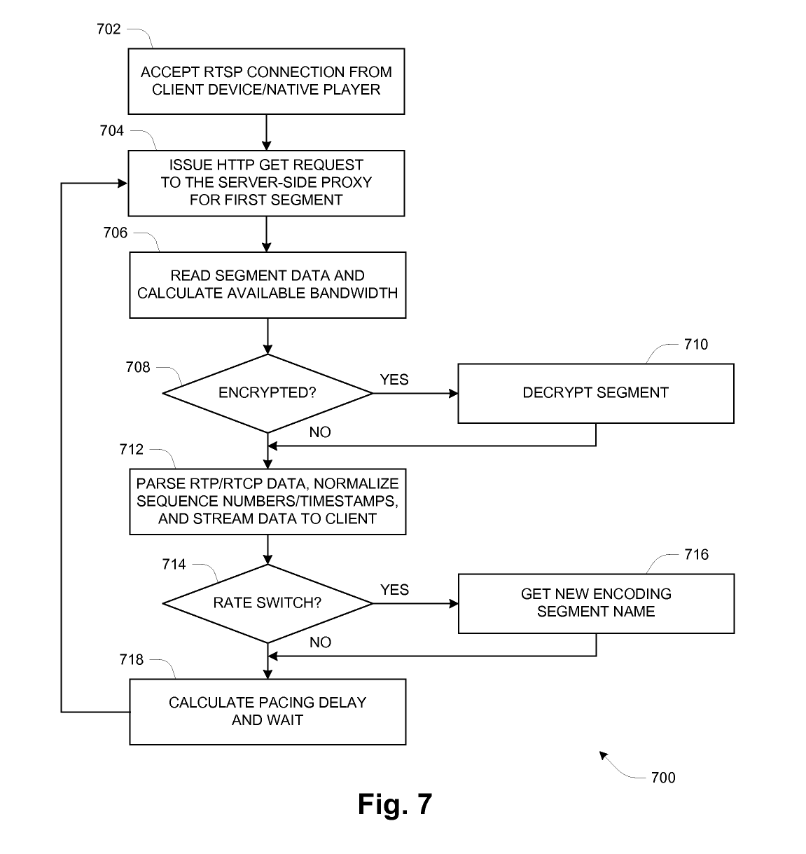

FIG. 7 is a flow chart 700 describing another process for retrieving content from the server-side proxy 106 or CDN 320 and redistributing that content over RTSP connections 114 or multicast trees 214 to client devices 102 from the client-side proxy 104. In step 702, the client-side proxy 104 accepts an RTSP connection from the client device 102. In step 704, the client-side proxy 104 then issues an HTTP request to the server-side proxy 106 or CDN 320. In one embodiment, an HTTPS connection using SSL/TLS secures the connection. The HTTP GET request indicates a segment name. The segment name contains meaningful information about the segment (e.g., segment number, encoding type, encryption method, and the source content identifier). Processing then proceeds to step 706 where the client-side proxy 104 waits for a segment to be retrieved from the server-side proxy 106 or CDN 320. When the segment is received by the client-side proxy 104, the client-side proxy 104 calculates the time it took to receive the segment, and uses that to compute a bandwidth estimate.

The segment pre-processing starts in step 708. In step 708, the segment is checked to see if it is encrypted. In one embodiment, encryption is denoted by the segment name. If the segment is encrypted, then processing proceeds to step 710 where the segment is decrypted. Once the segment is decrypted, or if the segment was not encrypted, processing proceeds to step 712. In step 712, the segment is parsed and the RTP/RTCP contents are retrieved. The RTP/RTCP headers are normalized so that port numbers, sequence numbers, and timestamps provided by the RTSP server 108 to the server-side proxy 106, are converted to match the connection parameters negotiated between the client-side proxy 104 and the client device 102. The RTP/RTCP packets are then queued for transmission to the client device 102. Relative time-based pacing is implemented so as not to overrun the client device 102. In one embodiment, each packet is paced exactly using the difference in timestamps from the original RTP/RTCP packets to determine the delay between packet transmissions. In another embodiment, packets are sent in bursts, using the different in timestamps from the original RTP/RTCP packets to determine the delay between packet burst transmissions. Once all the packets from the current segment have been sent, processing proceeds to step 714.

In step 714, a check is performed to see if a rate switch is desired. The bandwidth estimate information gathered in step 706 is compared with the bitrate of the segment that was just retrieved. If the available bandwidth is less than, or very near the current video encoding's bitrate, then a switch to a lower bitrate may be warranted. If the available bandwidth is significantly higher than the current encoding's bitrate and a higher bitrate encoding's bitrate, then a switch to a higher bitrate may be acceptable. If a rate switch is desired, processing proceeds to step 716 where the new bitrate and new segment name are determined. Once the new next segment is determined, or if no rate change was necessary, processing proceeds to step 718 where the pacing delay is calculated and enforced. The client-side proxy 104 does not need to retrieve the next segment until the current segment has played out; the pacing delay minimizes unnecessary network usage. In one embodiment, a pacing delay of (D-S/B-E), where D is the duration of the current segment, S is the size of the current segment (used as the estimated size of the next segment), B is the estimated available bandwidth, and E is an error value >0. The calculation takes the duration of the current segment, minus the retrieval time of the next segment, minus some constant to prevent underrun as the pacing delay. In another embodiment, no pacing delay is enforced, to provide maximum underrun protection. Processing waits in step 718 for the pacing delay to expire, then proceeds back to step 704 to issue the next segment retrieval HTTP GET request.

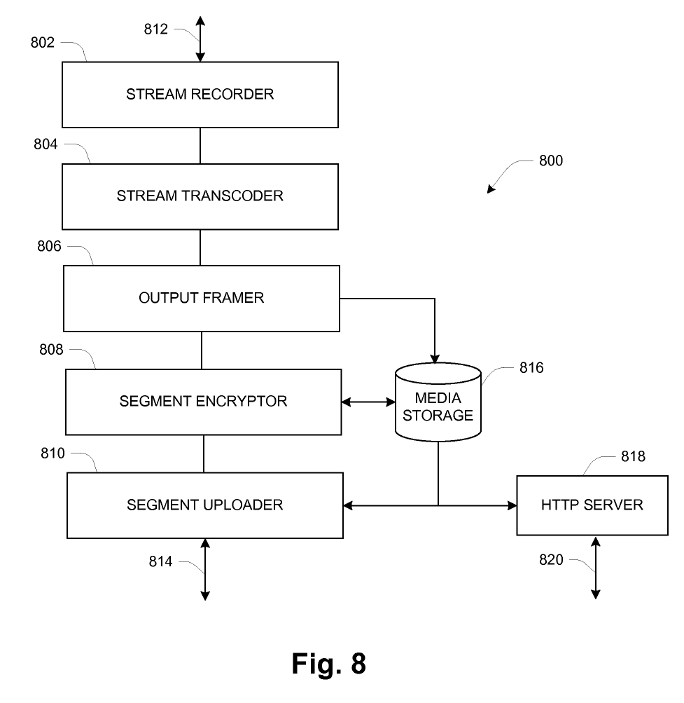

FIG. 8 is a diagram 800 of the components of the server-side proxy 106. A video stream 812 is recorded by the stream recorder 802. The stream recorder implements the specific protocol required to connect to the video stream 812. In one embodiment the protocol is RTMP. In another embodiment the protocol is RTSP/RTP. In another embodiment, the protocol is HTTP Live Streaming. In another embodiment, the protocol is Smooth Streaming. There are numerous live streaming protocols, as should be known to those skilled in the art, of which any would be suitable for the stream recorder 802. The stream recorder 802 passes recorded data to the stream transcoder 804, as it is received. The stream transcoder 804 is responsible for decoding the input stream and re-encoding the output video frames in the proper output bitrate, frame rate, and/or resolution. The stream transcoder 804 passes the re-encoded frames to the output framer 806. The output framer 806 is responsible for packing the encoded frames into the proper container format. In one embodiment, the stream transcoder 804 and output framer 806 support the H.264, H263, MPEG2, MPEG4, and WVM, video codecs and the MP3, AAC, AMR, and WMA audio codecs, along with the FLV, MOV, 3GP, MPEG2-TS and Advanced Systems Format (ASF) container formats. In another embodiment, the stream transcoder 804 and output framer 806 may support other standard or proprietary codecs and container formats. In one embodiment, the output framer supports RTP encapsulation as well as the custom segment encapsulation described in FIG. 4. There are numerous video and audio codecs and container formats, as should be known to those skilled in the art, of which any would be suitable for the stream transcoder 804 and output framer 806. The output framer 806 writes the formatted data into segment files in the local media storage 816. The output framer 806 is responsible for enforcing segment boundaries and durations. When the segments are complete, the output framer 806 notifies the segment encryptor 808. If segment encryption is required, the segment encryptor 808 reads the segment from the media storage 816, encrypts the segment, and writes the encrypted segment back out to the media storage 816.

In one embodiment, the segment uploader 810 is notified that the segment is ready for upload to the CDN 320 and the segment uploader 810 uploads the finished segments to the CDN 320 over connection 814. In one embodiment, the segment uploader 810 uses persistent HTTP connections to upload segments. In another embodiment, the segment uploader 810 uses persistent HTTPS connections to upload segments. In another embodiment, the segment uploader 810 uses onetime use HTTP connections to upload segments. In another embodiment, the segment uploader 810 uses onetime use HTTPS connections to upload segments. In another embodiment, the segment uploader 810 uses persistent FTP, SFTP, or SCP connections to upload segments. In another embodiment, the segment uploader 810 uses onetime use FTP, SFTP, or SCP connections to upload segments. In another embodiment, segment uploader 810 uses simple file copy to upload segments. There are numerous methods, with varying levels of security, which may be used to upload the files, as should be known to those skilled in the art, of which any would be suitable for the segment uploader 810.

In another embodiment, the completed segments are made available to an HTTP server 818. The HTTP server 818 accepts connections from the client-side proxy 104. Segments are read from the media storage 816 and delivered to the client-side proxy 104.

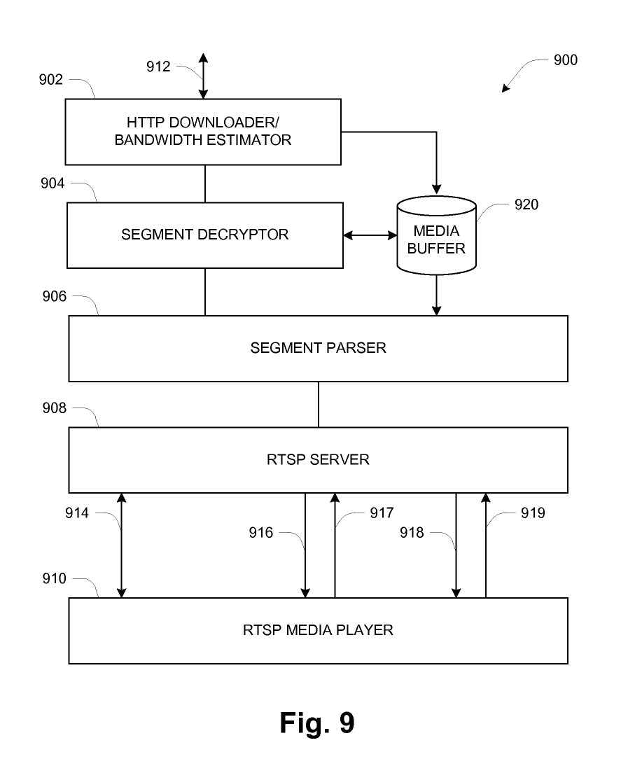

FIG. 9 is a diagram 900 of a client device, wherein the client device native media player 910 supports RTSP/RTP. In one embodiment, the client contains a downloader 902. The downloader 902 is responsible for interacting with the server-side proxy 106 or CDN 320 to retrieve segments. In one embodiment, the downloader 902 keeps track of multiple server-side proxies 106 or CDNs 320. Segments are retrieved from the primary server-side proxy 106 or CDN 320. If the response to a segment request fails to arrive in an acceptable amount of time, the downloader 902 issues a request to an alternate server-side proxy 106 or CDN 320. In one embodiment, the retrieval timeout is set as a percentage of the duration of the segment (e.g., 20%). The segments retrieved are written into the media buffer 920 and the downloader 902 notifies the segment decryptor 904. If the segment does not require decryption, the segment decryptor 904 notifies the segment parser 906 that the segment is ready. If the segment does require decryption, the segment decryptor 904 reads the segment from the media buffer 920, decrypts the segment, writes the decrypted segment back out to the media buffer 920, and notifies the segment parser 906 that the segment is ready. RTSP requires separate frame based delivery for audio and video tracks. The segments retrieved use the format 400 detailed in FIG. 4. The segments are parsed by the segment parser 906 to extract the individual audio and video RTP/RTCP frames. The RTP/RTCP frames are extracted and handed off to the RTSP server 908. In one embodiment, the segment parser 906 removes the segment from the media buffer 920 once it has been completely parsed. In another embodiment, the segment parser 906 does not purge segments until the media buffer 920 is full. The RTSP server 908 handles requests from the media player 910 on the RTSP control channel 914, and manages setting up the audio and video RTP channels 916 and 918, and the audio and video RTCP channels 917 and 919. The audio and video RTP/RTCP frames are sent in a paced manner, by the RTSP server 908 on their respective RTP/RTCP channels 916, 918, 917, and 919. In one embodiment, the relative inter-frame pacing information is gleaned from the RTP header timestamps. In one embodiment, the RTP headers are spoofed to produce valid sequence numbers and port numbers, etc., prior to delivery to the native media player 910.

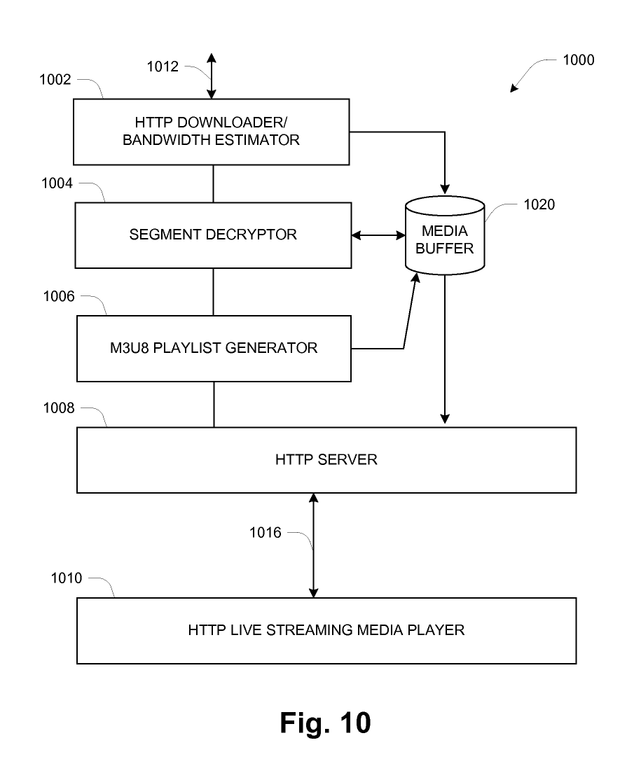

FIG. 10 is a diagram 1000 of a client device, wherein the client device native media player 1010 supports HLS. In one embodiment, the client contains a downloader 1002. The downloader 1002 is responsible for interacting with the server-side proxy 106 or CDN 320 to retrieve segments. In one embodiment, the downloader 1002 keeps track of multiple server-side proxies 106 or CDNs 320. Segments are retrieved from the primary server-side proxy 106 or CDN 320. If the response to a segment request fails to arrive in an acceptable amount of time, the downloader 902 issues a request to an alternate server-side proxy 106 or CDN 320. In one embodiment, the retrieval timeout is set as a percentage of the duration of the segment (e.g., 20%). The segments retrieved are written into the media buffer 1020 and the downloader 1002 notifies the segment decryptor 1004. If the segment does not require decryption, the segment decryptor 1004 notifies the m3u8 playlist generator 1006 that the segment is ready. If the segment does require decryption, the segment decryptor 1004 reads the segment from the media buffer 1020, decrypts the segment, writes the decrypted segment back out to the media buffer 1020, and notifies the m3u8 playlist generator 1006 that the segment is ready. The playlist generator 1006 is passed the segment file location, in the media buffer, by the segment decryptor 1004. The playlist generator 1006 updates the existing playlist adding the new segment and removing the oldest segment and passes the updated playlist to the HTTP server 1008. The playlist generator 1006 is also responsible for purging old segments from the media buffer 1020. In one embodiment, segments are purged from the media buffer 1020 as segments are removed from the playlist. In another embodiment, segments are only purged once the media buffer 1020 is full, to support the largest possible rewind buffer. The HTTP server 1008 responds to playlist polling requests from the media player 1010 with the current playlist provided by the playlist generator 1006. The HTTP server 1008 responds to segment requests from the media player 1010 by retrieving the segment from the media buffer 1020 and delivering it to the media player 1010. The media player 1010 connects to the HTTP server 1008 though a local host HTTP connection 1016.

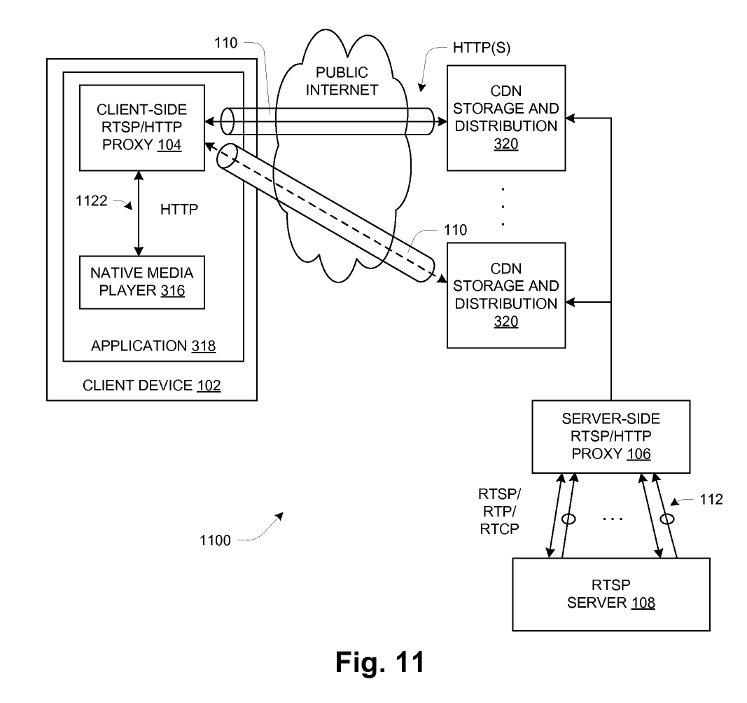

FIG. 11 is a block diagram 1100 for another embodiment of the present invention. As with FIGS. 1, 2, and 3, it shows an RTSP server 108, the server-side proxy 106, the client-side proxy 104, and a client device 102. As with FIG. 3, it shows multiple RTSP connections 112 to the server-side proxy 106. The server-side proxy 106 connects to a plurality of CDNs 320 for redundancy in the remote storage of the generated segments, allowing for redundancy in the retrieval of segments. The client-side proxy 104 is integrated into the client device 102 application 318. The native HLS media player 316 connects to the client-side HLS proxy 104 via an HTTP connection 1122. The server-side proxy 106 makes multiple simultaneous RTSP connections 112 to the RTSP server 108 and retrieves the same content encoded at different bitrates, frame rates, and/or resolutions. In one embodiment only the video bitrates differ between encodings. In another embodiment, the video bitrates, frame rates, and/or resolution may differ. Though only one client-side proxy 104 is shown, multiple client-side proxies 104 may connect to the CDNs 320.

In one embodiment, the client-side proxy 104 connects to only a primary CDN 320 via connection 110. In one embodiment, the primary CDN is configured by the user or via the application 318. In one embodiment, if the request for content from the primary CDN 320 does not produce a response in a set amount of time, the client-side proxy 104 will initiate a second connection 110′ to an alternate CDN 320′ to retrieve the content. In one embodiment, the alternate CDNs are configured by the user or via the application 318. This provides resiliency to the system against CDN 320 network access failures for either the client-side proxy 104 or the server-side proxy 106.

In another embodiment, the client-side proxy 104 connects to both a primary CDN 320 and an alternate CDN 320′, via connections 110 and 110′ respectively. In one embodiment, the primary and alternate CDNs 320 are configured by the user or via the application 318. The client-side proxy 104 issues requests for a segment to all CDNs 320. The connection 110 for the first response to begin to arrive is chosen and all other connections 110 are aborted. This provides not only resiliency against CDN 320 network access failures, but also optimizes retrieval latency based on initial response time.

In one embodiment, the connections 110 and 110′ between the client-side proxy 104 and the CDN 320 are persistent HTTP connections. In another embodiment, the connections 110 and 110′ are persistent HTTPS connections. In another embodiment, the connections 110 and 110′ are onetime use HTTP connections. In another embodiment, the connections 110 and 110′ are onetime use HTTPS connections. In another embodiment, the connections 110 and 110′ are persistent FTP, SFTP, or SCP connections. In another embodiment, the connections 110 and 110′ are onetime use FTP, SFTP, or SCP connections.

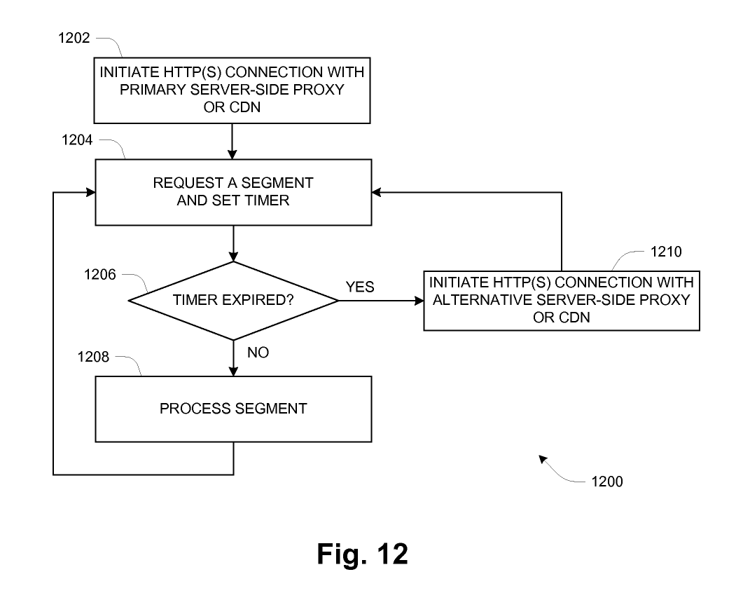

FIG. 12 is a flow chart 1200 describing the process of implementing segment retrieval resiliency between client-side proxies 104 and server-side proxies 106 or CDNs 320. In step 1202, the client-side proxy 104 initiates a connection 110 to a primary server-side proxy 106 or CDN 320 and proceeds to step 1204. In step 1204, the client-side proxy 104 issues a segment retrieval request to the primary server-side proxy 106 or CDN 320. The client-side proxy 104 also sets a timer to detect when the segment response is taking too long. The timer should be set for less than the segment duration (e.g., ⅕ the segment duration) to allow enough time to request the segment from an alternate server-side proxy 106 or CDN 320. In one embodiment, the timer may be set for zero time in order to initiate multiple simultaneous requests for segments from multiple server-side proxies 106 or CDNs 320. When the segment response is received, or if the timer expires, processing proceeds to step 1206. In step 1206, the client-side proxy 104 checks to determine if the segment was received or if the timer expired. If the segment was received processing proceeds to step 1208, otherwise processing proceeds to step 1210. In step 1208, the received segment is processed. In one embodiment, segment retrieval is paced, so segment processing includes delaying until the next segment retrieval time. Once segment processing is complete, processing proceeds back to step 1204 where the next segment to be retrieved is requested. In step 1210, the current segment retrieval request has been determined to be taking too long. A new connection 110′ may be initiated to an alternate server-side proxy 106 or CDN 320. In one embodiment, the current request is immediately aborted. In another embodiment, both the current connection 110 and the new connection 110′ are kept open until a response is received and the connection 110 with the fastest response is used, and the other connection 110 is closed. Once the alternate connection is opened, processing proceeds back to step 1204 where the segment request to the alternate server-side proxy 106 or CDN 320 is issued.

For purposes of completeness, the following provides a non-exclusive listing of numerous potential specific implementations and alternatives for various features, functions, or components of the disclosed methods, system and apparatus.

The streaming server may be realized as an RTSP server, or it may be realized as an HLS server, or it may be realized as an RTMP server, or it may be realized as a Microsoft Media Server (MMS) server, or it may be realized as an Internet Information Services (IIS) Smooth Streaming server.

Streaming data may be audio/video data. The audio/video may be encapsulated as RTP/RTCP data, or as MPEG-TS data, or as RTMP data, or as ASF data, or as MP4 fragment data.

Audio RTP, audio RTCP, video RTP, and video RTCP data within the file segments may be differentiated using custom frame headers. The custom frame headers may include audio/video track information for the frame, and/or frame length information, and/or end-of-stream delimiters.

Either fixed duration or variable duration segments may be used. Fixed duration segments may be of an integral number of seconds.

File segments may be encrypted, and if so then per-session cipher algorithms may be negotiated between proxies. Encryption algorithms that can be used include AES, RC4, and HC128. Different file segments may use different seed values for the cipher. Per-session seed modification algorithms may also be negotiated between proxies. A seed algorithm may use a segment number as the seed, or it may use a hash of the segment number and a shared secret. Storage devices used for storing file segments may include local disks, and/or remote disks accessible through a storage access network.

The storage devices may be hosted by one or more content delivery networks (CDNs). A CDN may be accessed through one or more of HTTP POST, SCP/SFTP, and FTP. The client-side proxy may retrieve segments from the CDN.

Data may be transferred between proxies using HTTP, and if so persistent connections between proxies may be used. Segments may be transferred securely using HTTPS SSL/TLS.

The client-side proxy may be a standalone network device. Alternatively, it may be embedded as part of an application in a client device (e.g., a mobile phone).

The client-side proxy may cache segments after they are retrieved. The segments may be cached only until the content which they contain has been delivered to the client media player, or they may be cached for a set period of time to support rewind requests from the client media player.

The server-side proxy may initiate a plurality of connections to a single streaming server for a single media, and may request a different bitrate for the same audio/video data on each connection. The client-side proxy may request a specific bitrate from the server-side proxy.

The server-side proxy may initiate a plurality of connections to a plurality of streaming servers for a single media. Alternatively, it may initiate a plurality of connections to a plurality of streaming servers for a plurality of different media. Media data from different connections may be spliced together into a single stream. For example, advertisements may be spliced in, or the data from different connections may be for different viewing angles for the same video event.

The client-side proxy may stream the segment data to the media player on the client device, for example using appropriate RTP/RTCP ports to an RTSP media player. Streaming may be done via IP multicast to client media players. The server-side proxy may act as an MBMS BCMCS content provider, and the client-side proxy may act as an MBMS BCMCS content server. Data may be made available to the client via HTTP for an HLS media player.

The server-side proxy may connect to the streaming server to retrieve a high bitrate media. The high bitrate media may be transcoded into a plurality of different encodings, e.g., a plurality of different bitrates, a plurality of different frame rates, a plurality of different resolutions. Independent file segments may be generated for each encoding. A plurality of container formats may be supported, such as MPEG-TS format or a custom RTP/RTCP format. All of the different encoding and format segment files may be made available to the client-side proxy through the storage device.

The client-side proxy may request segments from a single server-side proxy. A segment may be retrieved from an alternate first proxy if the primary first proxy does not respond with an acceptable amount of time.

The client-side proxy may request segments from a plurality of server-side proxies, and may accept the first response that is received. Requests whose responses were not received first may be cancelled.

Though various implementations of both the client-side proxy and the server-side proxy are described, the heterogeneous permutations of multiple client-side proxy implementations and server-side proxy implementations are all valid. Any client-side proxy implementations, be they embedded in a mobile device application, or as a stand-alone appliance, using multicast or unicast delivery, may be paired with any of the server-side implementations, be they delivering segments via a local HTTP server or through one or more CDNs and connecting to one or multiple streaming servers. The abstraction of the tunneling functionality provided by the client-side and server-side proxies allow for transparent usage by the client device. The client device connects to the client-side proxy, regardless of its specific implementation. The server-side proxy connects to the streaming servers, regardless of its specific implementation. The client-side proxy and the server-side proxy communicate with each other to transparently tunnel media content from the streaming server to the client device. The tunneling may be through various physical transport mechanisms, including using a CDN as an intermediate storage device. It should be understood that the examples provided herein are to describe possible independent implementations for the client-side and server-side proxies, but should not be taken as limiting the possible pairing of any two client-side or server-side proxy implementations.

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

What is claimed is:

1. A method of operating a server-side proxy in a streaming data delivery system, comprising:
connecting to a streaming server to receive streaming data;
aggregating the streaming data into file segments and storing the file segments on one or more storage devices; and
transferring the file segments from the storage devices to a client-side proxy for delivery to a client device.

2. A method according to claim 1, wherein connecting to the streaming server comprises creating one or more real-time streaming connections.

3. A method according to claim 2, wherein the real-time streaming connections include a plurality of connections to the streaming server, the connections carrying the streaming data at respective distinct bit rates.

4. A method according to claim 2, wherein the streaming server is realized as a selected one of Real-Time Streaming Protocol (RTSP) server, an HTTP Live Streaming (HLS) server, a Real-Time Messaging Protocol (RTMP) server, a Microsoft Media Server (MMS) server, and an Internet Information Services (IIS) Smooth Streaming server.

5. A method according to claim 1, wherein the streaming data includes audio/video data encapsulated as a selected one of Real-Time Protocol/Real-Time Control Protocol (RTP/RTCP) data, MPEG Transport Stream (MPEG-TS) data, Real-Time Messaging Protocol (RTMP) data, Advanced Systems Format (ASF) data, and MPEG-4 (MP4) fragment data.

6. A method according to claim 1, wherein the streaming server is one of a plurality of streaming servers, and connecting to the streaming server is part of establishing respective connections to each of the plurality of streaming servers.

7. A method according to claim 6, wherein the connections to different streaming servers carry respective distinct media.

8. A method according to claim 7, further including splicing media from distinct ones of the connections to create a single output stream to be delivered to the client device.

9. A method according to claim 1, wherein transferring the file segments includes encrypting the file segments from the storage devices to form encrypted file segments and transferring the encrypted file segments to the client-side proxy.

10. A method according to claim 1, wherein aggregating the file segments includes transcoding the file segments into transcoded file segments and aggregating the transcoded file segments for storing on the storage devices and transferring to the client-side proxy.

11. A method according to claim 1, wherein the file segments contain data of distinct types differentiated through use of custom frame headers each including media information, length information and an end-of-stream delimiter.

12. A method according to claim 1, wherein transferring includes use of a secure connection between the server-side proxy and the client-side proxy to securely transfer the file segments to the client-side proxy.

13. A server-side proxy for use in a streaming data delivery system, comprising:
memory;
a processor;
input/output circuitry for connecting the server-side proxy to a streaming server, one or more storage devices, and a client-side proxy; and
one or more data buses by which the memory, processor and input/output circuitry are coupled together,
the memory and processor being configured to store and execute program instructions to enable the server-side proxy to perform the method of claim 1.

14. A method of operating a client-side proxy in a streaming data delivery system, comprising:
connecting to a server-side proxy to receive file segments of a data stream originated by a streaming server to which the server-side proxy is connected;
parsing the file segments to generate native live stream data; and
serving the native live stream data to one or more clients for live media playback.

15. A method according to claim 14, wherein serving the native live stream data to the clients comprises creating a respective real-time streaming connection to the respective client.

16. A method according to claim 15, wherein the real-time streaming connection is selected from a Real-Time Streaming Protocol (RTSP) connection and an HTTP Live Streaming (HLS) connection.

17. A method according to claim 14, wherein connecting to the server-side proxy includes establishing a persistent hypertext transport protocol (HTTP) connection with the server-side proxy.

18. A method according to claim 14, wherein the file segments are encrypted as received from the server-side proxy and parsing the file segments includes decrypting the file segments to form decrypted file segments, and serving the native live stream data includes streaming data from the decrypted file segments to the clients.

19. A method according to claim 14, further including monitoring for a need for a rate switch to change a rate at which the data of the file segments is received from the server-side proxy, and upon detecting the need for a rate switch then closing an existing connection to the server-side proxy and establishing a new connection to the server-side proxy for receiving the file segments at a new rate.

20. A method according to claim 14, wherein connecting to the server-side proxy includes use of non-persistent hypertext transport protocol (HTTP) connections with the server-side proxy, each non-persistent HTTP connection used for receiving a respective one of the file segments.

21. A method according to claim 14, further including establishing a multicast distribution tree to which the clients can connect, and wherein serving the native live stream data includes transmitting the native live stream data to the multicast distribution tree for delivery to the clients.

22. A method according to claim 14, wherein each file segment is requested from a plurality of content delivery networks coupled to the server-side proxy, and a requested file segment is received from a first one of the content delivery networks to deliver the requested file segment.

23. A method according to claim 22, further including:
monitoring for delivery of the requested file segment via one of the content delivery networks, and receiving the requested file segment from the one content delivery network if delivered thereby; and
in the event that the requested file segment is not delivered by the one content delivery network, then requesting the file segment from another content delivery network.

24. A method according to claim 22, wherein:
multiple parallel requests for the requested file segment are submitted to different ones of the content delivery networks;
the requested file segment is received from the content delivery network having the fastest response; and
the requests to the other content delivery networks are.

25. A client-side proxy for use in a streaming data delivery system, comprising:
memory;
a processor;
input/output circuitry for connecting the client-side proxy to one or more client media players and a server-side proxy; and
one or more data buses by which the memory, processor and input/output circuitry are coupled together,
the memory and processor being configured to store and execute program instructions to enable the client-side proxy to perform the method of claim 14.

26. A method for distributing live streaming data to clients, comprising:
connecting to a streaming server from a first proxy;
aggregating streaming data into file segments at the first proxy;
writing the file segments to a plurality of storage devices;
transferring the file segments from the storage devices to a second proxy;
decoding and parsing the file segments at the second proxy to generate native live stream data; and
serving the native live stream data to clients for live media playback.

27. A live streaming system for distributing live streaming data to clients, comprising:
a first proxy configured and operative to (1) connect to a streaming server, (2) aggregate streaming data into file segments, (3) write the file segments to a plurality of storage devices, and (4) transfer the file segments from the storage devices to a second proxy; and
a second proxy configured and operative to (1) receive the file segments from the first proxy, (2) decode and parse the file segments to generate native live stream data, and (3) serve the native live stream data to clients for live media playback.
